(19) United States
(12) Patent Application Publication
(10) Pub. No.: US 2016/0356232 A1
(43) Pub. Date: Dec. 8, 2016

(54) SYSTEM AND METHOD OF CONTROLLING SAFETY DURING KEY-OFF OF VEHICLE

(71) Applicants: Hyundai Motor Company, Seoul (KR); Kia Motors Corporation, Seoul (KR)

(72) Inventor: Hyun Kim, Hwaseong (KR)

(21) Appl. No.: 14/852,568

(22) Filed: Sep. 13, 2015

(30) Foreign Application Priority Data
Jun. 5, 2015 (KR) 10-2015-0079604

(51) Int. Cl. F02D 41/22; F02D 41/06; F02D 41/08

(52) U.S. Cl. CPC F02D 41/22; F02D 41/08; F02D 41/065; F02D 2041/227

(57) ABSTRACT

A method and system of controlling safety during a key-off of a vehicle are provided. The method includes detecting whether an ignition key is switched off and when the ignition key is switched off whether the speed of the vehicle is greater than a preset speed is determined. In addition, when the speed of the vehicle is greater than the preset speed, the vehicle is maintained in a startup on state and an idle mode is started. A limp home mode is then entered after starting the idle mode.

### CROSS-REFERENCE TO RELATED APPLICATION

The present application claims priority to Korean Patent Application No. 10-2015-0079604, filed Jun. 5, 2015, the entire contents of which is incorporated herein for all purposes by this reference.

### BACKGROUND

(a) Technical Field

The present invention relates to a system and method of controlling safety during a key-off of a vehicle, by which the driver may safely drive the vehicle when a start-up is abnormally switched off while the vehicle is driven.

(b) Background Art

In recent years, a start-up of an engine has turned off and an airbag has failed to be operated when the driver unintentionally deviates a start-up key with a knee or other object in a drive (e.g., run) position. Accordingly, when the start-up key unintentionally deviates from the run position while the vehicle is driven, supply of ignition power is stopped, and thus a collision danger increases due to engine power, power steering, and power braking functions.

In particular, an engine control unit (ECU) is started or brought into a sleep mode by ignition power, and when the key position deviates from the run position, supply of ignition power is stopped and the engine control unit enters a sleep mode after a power latch time period (e.g., about 3 to 5 seconds). In other words, since the engine control unit is switched off by the sleep mode, the start-up of the engine is stopped and the power steering and power braking functions are also switched off as the start-up of the engine is stopped, thus increasing a collision risk.

The description provided above as a related art of the present invention is merely for helping in understanding the background of the present invention and should not be construed as being included in the related art known by those skilled in the art.

### SUMMARY

The present invention provides a control method and system that prevent the start-up of the vehicle from being switched off while the vehicle travels as the vehicle is driven in a limp mode based on the vehicle speed when ignition power is switched off while the vehicle is driven.

According to the present invention, a method of controlling safety at a key-off time of a vehicle may include: detecting whether an ignition key is switched off; in response to detecting that the ignition key is switched off, determining that the speed of the vehicle is greater than a preset speed; in response to detecting that the speed of the vehicle is greater than the preset speed, maintaining the vehicle in a startup on state and starting an idle mode; and after starting the idle mode, starting a limp home mode.

In the limp home mode, an output of the engine may be restricted to a predetermined output or less. In addition, the engine may be idled when the speed of the vehicle is less than a predetermined speed. The method further includes: operating the vehicle to enter a sleep mode when the speed of the vehicle is a preset speed or less. Thereafter, the ECU may be switched off when a predetermined time period elapses.

According to the method of controlling safety at a key-off time of a vehicle, the vehicle may be driven with minimum power even when the ignition key is switched off due to a driver error while the vehicle is driven, and a safety of the driver may be secured from a secondary accident that may occur as the start-up of the engine is completely switched off.

Furthermore, the safety of the vehicle to which the control method of the present invention is applied may be improved, and a product value of the vehicle may be improved. In addition, since the vehicle may be driven in an idle mode and a limp home mode even when the ignition key is switched off while the drive does not recognize that the ignition key is switched off, the driver may recognize a breakdown situation to allow the driver to promptly handle with the breakdown.

### BRIEF DESCRIPTION OF THE DRAWINGS

The above and other features of the present invention will now be described in detail with reference to exemplary embodiments thereof illustrated by the accompanying drawings which are given herein below by way of illustration only, and thus are not limitative of the present invention, and wherein:

FIG. 1 is a flowchart illustrating a system for controlling safety during a key-off of a vehicle according to an exemplary embodiment of the present invention; and

FIG. 2 is a flowchart illustrating a method for controlling safety during a key-off of a vehicle according to an exemplary embodiment of the present invention.

It should be understood that the appended drawings are not necessarily to scale, presenting a somewhat simplified representation of various exemplary features of the present invention as disclosed herein, including, for example, specific dimensions, orientations, locations, and shapes will be determined in part by the particular intended application and use environment. In the figures, reference numbers refer to the same or equivalent parts of the present invention throughout the several figures of the drawing.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an ” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter, a system for controlling safety during a key-off of a vehicle according to exemplary embodiments of the present invention will be described with reference to the accompanying drawings.

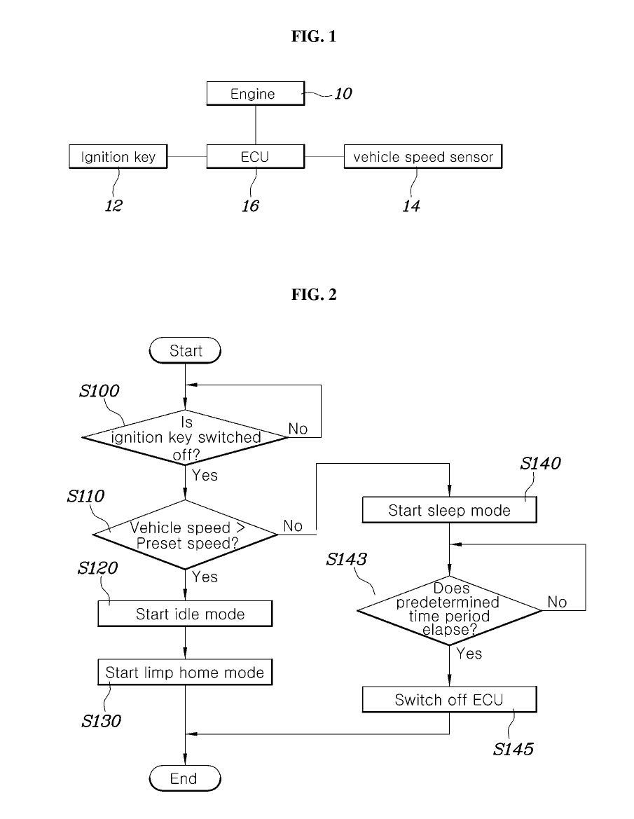

FIG. 1 is a flowchart illustrating a system for controlling safety during a key-off of a vehicle according to an exemplary embodiment of the present invention. Referring to FIG. 1, the system may include: an engine 10; an ignition key 12 switched on and off by the driver; a vehicle speed sensor 14 configured to sense a vehicle speed of the vehicle; and an ECU 16 (e.g., a controller) configured to detect a switching off operation of the ignition key 12, receive a vehicle speed value sensed by the vehicle speed sensor 14, maintain the vehicle in a start-on state and drive the engine 10 in an idle mode when the vehicle speed is greater than a preset speed, and drive the engine 10 in a limp home mode after driving the engine 10 in an idle mode.

The ignition key 12 may be switched on and off based on a driver manipulation while being switched on, and may be switched off even when an ignition power source is abnormal (e.g., an error of a switch, an error of a wire, or the like). A detailed operation of the system for control safety during a key-off of the vehicle and a method thereof will be described below.

Hereinafter, the method for controlling safety during a key-off of a vehicle according to exemplary embodiments of the present invention will be described with reference to the accompanying drawings.

FIG. 2 is a flowchart illustrating a method for controlling safety during a key-off of a vehicle according to an exemplary embodiment of the present invention. Notably, the controller may be configured to execute the method as described herein below. That is, the controller may be configured to operate the various units. Referring to FIGS. 1 and 2, the method may include: detecting whether an ignition key is switched off (S100); determining whether a speed of the vehicle is greater than a preset speed (S110) in response to detecting that the ignition key is switched off; maintaining the vehicle in a start-on state and starting an idle mode (S120) in response to detecting that the speed is greater than the preset speed; and starting a limp home mode (S130) after starting an idle mode.

According to the related art, when the ignition key is switched off, an ECU is collectively switched off regardless of the vehicle speed. Accordingly, when the ECU is switched off, a power steering function and a power braking function are both disenabled while the startup of the engine is switched off. Therefore, control logic for determining whether the ECU is switched off together when the ignition key is switched off while the vehicle is driven is necessary.

Furthermore, when the ignition key 12 is switched off by the driver or switched off due to an error of an ignition power source S 100, the ECU 16 of the exemplary embodiment may be configured to receive a vehicle speed value from a vehicle speed sensor 14 to determine whether a cause for the switching-off of the ignition key 12 is normal or abnormal (e.g., determine driver intent). For example, when the driver intends to switch off the startup of the engine, the ignition key 12 may be switched off after the vehicle is stopped and the vehicle speed may be detected to be a preset speed or less. Accordingly, when the vehicle speed is the preset speed or less, the ECU 16 may be configured to execute switching-off of the start-up of the engine by determining a normal start-up off situation (e.g., by determining driver intention).

However, when the ignition key 12 is switched off while the vehicle is being driven, is the ECU 16 may be configured to determine an abnormal start-up off situation. Particularly, when the vehicle speed is detected to be greater than the preset speed, the ECU 16 may be configured to prevent the start-up of the engine 10 from being switched off and operate the engine 10 to travel with minimum power, that is, in an idle mode, to guide the vehicle may be guided to a shoulder of a road S120 (e.g., to guide the vehicle off of the road to a safer location). In particular, the preset speed may be set to a speed in a low speed area, for example, as about 0 to 20 km/h. However, since the speed may vary based on manufacturer settings, the vehicle, or a driving condition, the low speed area is not limited to a specific value.

In addition, since the vehicle may be operated to start a limp home mode in addition to an idle mode, a stable low speed travel of the vehicle may be guided S130. Particularly, in the limp home mode, an output of the engine 10 may be limited or restricted to a predetermined output or less and the engine 10 may be operated to be driven in an idle mode when the vehicle speed is less than a predetermined speed. In other words, when the vehicle starts a limp home mode, the ECU 16 may be configured to detect the vehicle speed using the vehicle speed sensor 14. In response to determining that the speed of the vehicle is a high speed, that is, a predetermined speed or greater, the ECU 16 may be configured to prevent the engine from being operated by force, by restricting the output of the engine 10 to a predetermined output or less and may be configured to notify the driver that a breakdown may occur during driving of the vehicle.

Furthermore, in response to determining a low speed operation since the speed of the vehicle is less than a predetermined vehicle speed, the ECU 16 may be configured to idle the engine 10 by force to switch off the engine 10 to prevent an accident or collision and then may be configured to notify the driver of a breakdown. Particularly, the output may be at least one of an engine revolutions per minute (RPM) and an engine torque. For example, in a limp home mode, when the engine RPM of the vehicle reaches about 2000 RPM or the engine torque reaches about 50% of the maximum torque, the ECU 16 may be configured to limit or restrict the engine output to inform the driver of a breakdown and guide an emergency operation (e.g., guide the vehicle to a safer location). The limitation values are merely to describe an exemplary embodiment of the present invention, and may vary based on manufacturer settings, the vehicle, or the driving condition, and the value should not be limited.

Moreover, when the vehicle speed is a preset speed or less after the determination step S110, the vehicle may be operated to enter a sleep mode (S140). In other words, when the vehicle speed is a preset speed or less, the ECU 16 may be configured to determine that the driver stops the vehicle (e.g., a driver intention of stopping the vehicle) or the vehicle is driven at a low speed, and thus may be configured to operate the vehicle to enter a sleep mode, that is, a start-up off process. When a predetermined time period elapses S143 after the control step S140, the ECU 16 may be switched off S145. In other words, when the vehicle enters the sleep mode, the vehicle may remain in a stand-by mode (e.g., idle) such that a predetermined time period elapses to allow electrical energy to be exhausted when the ignition key of the vehicle is switched off. Thereafter, a potential electric shock may be prevented by switching off the ECU 16.

According to the method of controlling safety during a key-off of a vehicle, the vehicle may be driven with minimum power even when the ignition key is switched off due to a driver error while the vehicle is driven, and a safety of the driver may be secured from a secondary accident that may occur as the start-up of the engine is completely switched off.

Furthermore, the safety of the vehicle to which the control method of the present invention is applied may be improved, and a product value of the vehicle may be improved. In addition, since the vehicle may be driven in an idle mode and a limp home mode even when the ignition key is switched off while the driver does not recognize that the ignition key is switched off, the driver may recognize a breakdown situation to allow the drive to promptly handle the breakdown.

The invention has been described in detail with reference to exemplary embodiments thereof. However, it will be appreciated by those skilled in the art that changes may be made in these exemplary embodiments without departing from the principles and spirit of the invention, the scope of which is defined in the appended claims and their equivalents.

What is claimed is:

1. A method of controlling safety during a key-off of a vehicle, the method comprising:
detecting, by a controller, whether an ignition key is switched off;
determining, by the controller, whether the speed of the vehicle is greater than a preset speed when the ignition key is switched off;
maintaining, by the controller, the vehicle in a startup on state and starting an idle mode when the speed of the vehicle is greater than the preset speed; and
entering, by the controller, the vehicle into a limp home mode after starting the idle mode.

2. The method of claim 1, wherein in the limp home mode, an output of the engine is restricted to a predetermined output or less.

3. The method of claim 1, wherein in the limp home mode, the engine is idled when the speed of the vehicle is less than a predetermined speed.

4. The method of claim 1, further comprising:
operating, by the controller, the vehicle to enter a sleep mode when the speed of the vehicle is a preset speed or less.

5. The method of claim 4, wherein an engine control unit (ECU) is switched off when a predetermined time period elapses after the vehicle is operated to enter a sleep mode.

6. A system of controlling safety during a key-off of a vehicle, comprising:
a memory configured to store program instructions; and
a processor configured to execute the program instructions, the program instructions when executed configured to:
detect whether an ignition key is switched off;
determine whether the speed of the vehicle is greater than a preset speed when the ignition key is switched off;
maintain the vehicle in a startup on state and starting an idle mode when the speed of the vehicle is greater than the preset speed; and
enter the vehicle into a limp home mode after starting the idle mode.

7. The system of claim 6, wherein in the limp home mode, an output of the engine is restricted to a predetermined output or less.

8. The system of claim 6, wherein in the limp home mode, the engine is idled when the speed of the vehicle is less than a predetermined speed.

9. The system of claim 6, wherein the program instructions when executed are further configured to:
operate the vehicle to enter a sleep mode when the speed of the vehicle is a preset speed or less.

10. The system of claim 9, wherein an engine control unit (ECU) is switched off when a predetermined time period elapses after the vehicle is operated to enter a sleep mode.
